(19) United States
(12) Patent Application Publication
(10) Pub. No.: US 2012/0172148 A1
(43) Pub. Date: Jul. 5, 2012

(54) PORTABLE GOLF BALL TRACKING SYSTEM

(76) Inventor: Denise FREEMAN, Toano, VA (US)

(21) Appl. No.: 12/983,055

(22) Filed: Dec. 31, 2010

(51) Int. Cl. A63B 57/00; A63B 43/00; A63B 69/36; G01S 19/51

(52) U.S. Cl. 473/353; 342/357.34; 473/409

(57) ABSTRACT

A golf ball tracking system that includes a golf hall having a first transmitting and receiving unit configured to wirelessly receive and transmit signals to and from the golf ball, and a signal amplifying unit configured to receive the signals from the first transmitting and receiving unit and to amplify the signals The golf ball tracking system further includes a remote controlling unit having a second transmitting and receiving unit configured to wirelessly receive and transmit signals to and from the first transmitting and receiving unit, and a lighting element configured to produce a plurality of light signals based on the signals received from the golf ball such that the light signals indicate proximity of the golf ball to the remote controlling unit.

### BACKGROUND

The present invention relates to a tracking device, and more specifically, to a portable golf ball tracking system utilizing global positioning system (GPS) technology for tracking golf balls.

Occasionally, while playing the game of golf, the users may lose their golf halls. These misdirected golf balls may be difficult for the users to locate. The users may lose time and concentration in trying to locate the golf balls. Also, the users may be penalized during competition for loss of the golf balls. Depending upon the direction that the golf halls are hit, these golf halls may end up in areas that not visible by the user, for example, water, deep trenches and heavily wooded areas.

Therefore, it is desirable to provide a tracking device that is both portable and efficient in locating misdirected and wayward golf halls.

### SUMMARY

According to one embodiment of the present invention, a golf ball tracking system is provided. The golf ball tracking system including a golf ball having a first transmitting and receiving unit configured to wirelessly receive and transmit signals to and from the golf ball, and a signal amplifying unit configured to receive the signals from the first transmitting and receiving unit and to amplify the signals The golf ball tracking system further including a remote controlling unit having a second transmitting and receiving unit configured to wirelessly receive and transmit signals to and from the first transmitting and receiving unit, and a lighting element configured to produce a plurality of light signals based on the signals received from the golf ball such that light signals indicate proximity of the golf ball to the remote controlling unit.

According to another embodiment of the present invention, a method of tracking golf balls via a golf hall tracking system is provided. The method includes activating, via a user, a remote controlling unit for tracking a golf ball, wirelessly transmitting, via the remote controlling unit, a first signal to the golf ball and wirelessly transmitting and amplifying a second signal via the golf ball to the remote controlling unit, upon receiving the first signal at the golf ball based on proximity of the golf ball to the remote controlling unit.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a diagram illustrating a golf ball tracking system that can be implemented within embodiments of the present invention.

FIG. 2 is a diagram illustrating a golf ball of the system shown in FIG. 1 that can be implemented within embodiments of the present invention.

FIG. 3 is a diagram illustrating a remote controlling unit of the system that can be implemented within embodiments of the present invention.

FIG. 4 is graph illustrating a correlation between an amplification strength of the signal transmitting from the golf ball and the proximity of the golf ball that can be implemented within embodiments of the present invention.

FIG. 5 is a graph illustrating a correlation between a timing frequency of the light signals produced by a lighting element of the remote controlling unit and the proximity of the golf ball that can be implemented within embodiments of the present invention.

FIG. 6 is a graph illustrating an amplification strength of a signal from the golf ball and a timing frequency of the light signals produced by a lighting element of the remote controlling unit that can be implemented within embodiments of the present invention.

FIG. 7 is a diagram illustrating an example of the remote controlling unit that can be implemented within embodiments of the present invention.

FIG. 8 is a diagram illustrating another example of the remote controlling unit that can be implemented within embodiments of the present invention.

FIG. 9 is a flow chart illustrating a method for tracking golf balls using the system shown in FIG. 1 that can be implemented within embodiments of the present invention.

### DETAILED DESCRIPTION

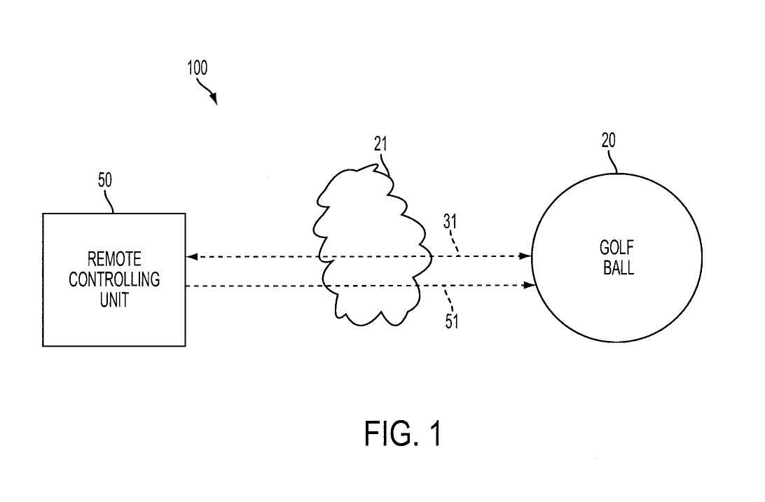

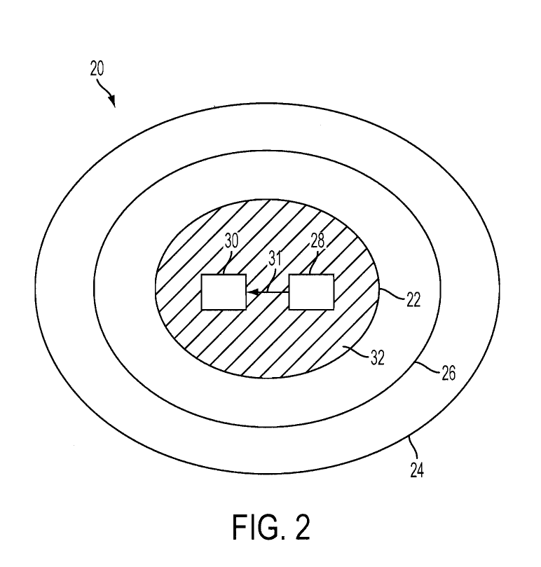

Embodiments of the present invention disclose a system and method for tracking misplaced and wayward golf balls. FIG. 1 is a diagram illustrating a golf ball tracking system that can be implemented within embodiments of the present invention. As shown in FIG. 1, a golf ball tracking system includes a golf ball 20 and a remote controlling unit 50 for tracking the golf ball 20. According to an embodiment of the present invention, the golf ball 20 and the remote controlling unit 50 communication wirelessly over a wireless network 21. This communication may be performed using global positioning system (GPS) technology. The wireless network 21 may be the Internet, for example, however any wireless network suitable for the purpose set forth herein may be utilized. Additional details regarding the golf ball 20 will now be discussed with reference to FIG. 2.

According to an embodiment of the present invention, the golf ball 20 includes a core area 22, an outer shell 24 forming an external surface of the golf ball 20, and an inner shell 26 disposed between the core area 22 and the outer shell 24. According to an embodiment of the present invention, the core area 22 includes a first transmitting and receiving unit 28 for wirelessly receiving and transmitting signals to and from the golf 20 and a signal amplifying unit 30 for receiving the signals 31 from the first transmitting and receiving unit 28 and amplifying the signals 31. A shock-absorbing material 32 is also formed in the core area 22 and surrounds the first transmitting and receiving unit 28 and the signal amplifying unit 30. The shock-absorbing material may be made of Sorbothane which is a visco-elastic polymer that exhibits properties of both liquids (e.g., viscous solutions) and solids (e.g., elastic materials) for shock and vibration damping, isolation, and shock absorption. Alternatively, the shock-absorbing material 32 may be formed of any soft resilient foam-type material or other material suitable for the purpose set forth herein. In addition, the material 32 may be formed of a water-resistant material. According to an embodiment of the present invention, the golf ball 20 is water-resistant, therefore, the first transmitting and receiving unit 28 and the signal amplifying unit 30 are not damaged if the golf ball 20 is submerged in water.

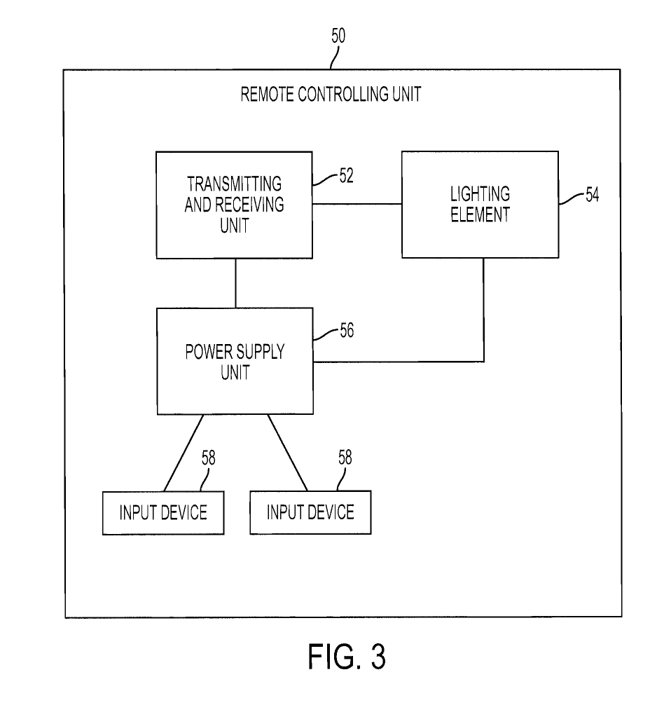

As mentioned above with reference to FIG. 1, the golf ball 20 communicates with the remote controlling unit 50 in accordance with an embodiment of the present invention. Details regarding the remote controlling unit 50 will now be discussed below with reference to FIG. 3. FIG. 3 is a diagram illustrating the remote controlling unit of the system 100 that can be implemented within embodiment of the present invention.

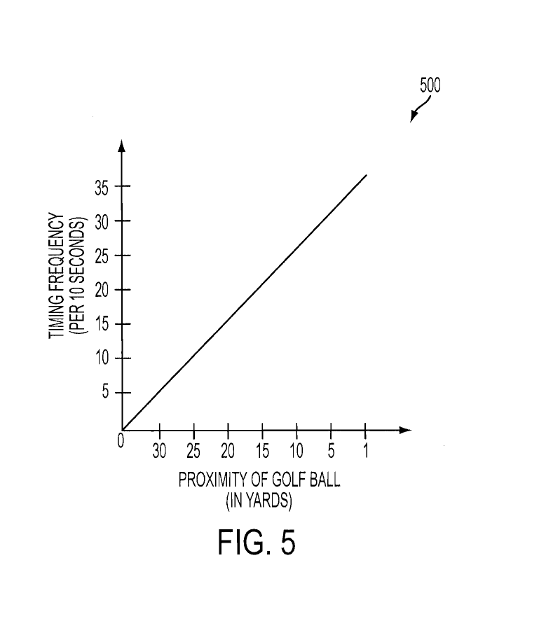

As shown in FIG. 3, the remote controlling unit 50 includes a second transmitting and receiving unit 52 configured to wirelessly receive and transmit signals 51 (as depicted in FIG. 1, for example) to and front the first transmitting and receiving unit 28 of the golf hall 20. The remote controlling unit 50 further includes a lighting element 54 configured to produce a plurality of light signals based on the signals 31 received from the golf ball 20, wherein the light signals 51 indicate proximity of the golf ball 20 to the remote controlling unit 50. According to an embodiment of the present invention, the lighting element 54 may be at least one light emitting diode or other suitable lighting element for the purpose set forth herein. The number of lighting signals produced may be based on the closeness of the golf ball 20 to the remote controlling unit 50. Additional details regarding the correlation between the timing frequency of the lighting element 54 and the proximity of the golf ball 20 will be discussed later with reference to FIG. 5. The remote controlling unit 50 further includes a power supply unit 56 which supplies power to the remote controlling unit 50. According to an embodiment of the present invention, the lighting element 54 may also indicate a status of the power of the remote controlling unit 50 in addition to the proximity of the golf hall 20. Further, the remote controlling unit 50 includes at least one input device 58 used to activate and deactivate the remote controlling unit 50. The input device 58 may be a combined on/off pushbutton, separate on and off pushbuttons, a touchscreen type input device, or any other suitable type of inputting mechanism. According to an embodiment of the present invention, when activating the remote controlling unit 50, the second transmitting and receiving unit 52 transmits a first signal 51 to the first transmitting and receiving unit 28 to determine a location of the golf ball 20 and upon receiving the first signal 51, the first transmitting and receiving unit 28 transmits a second signal 31 to the second transmitting and receiving unit 52. The second signal 31 being amplified via the signal amplifying unit 32 to indicate the proximity of the golf ball 20 from the remote controlling unit 50.

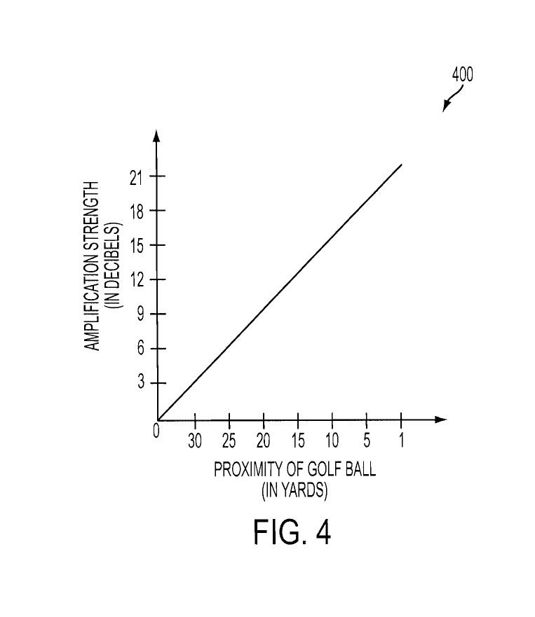

According to an embodiment of the present invention, there may be a direct correlation between the amplification strength of the amplified signal 31 and the proximity of the golf hall 20 to the remote controlling unit 50. FIG. 4 is a graph illustrating this correlation. As shown in the graph 400, the closer the golf ball 20 is to the remote controlling unit 50, the higher the amplification strength of the amplified signal 31. For example, as shown, if the golf ball 20 is approximately 30 yards from the remote controlling unit 50, the amplification strength of the amplified signal 31 is approximately 3 decibels (db) whereas if the golf ball 20 is approximately 5 yards from the remote controlling unit 50, the amplification strength of the amplified signal 31 is approximately 18 decibels (db). Thus, the closer the user gets to the golf ball 20, the louder the signal 31 can be heard.

According to another embodiment of the present invention, a timing frequency of light signals emitted from the lighting element 54 is in direct correlation with the proximity of the golf ball 20 as discussed with reference to the graph in FIG. 5. As shown in the graph 500 in FIG. 5, the timing frequency of the light signals emitted from the lighting element 54 increases per 10 seconds based on the closeness of the golf ball 20 to the remote controlling unit 50. For example, if the golf ball 20 is approximately 30 yards from the remote controlling unit 50, then the lighting element 54 produces lighting signals at a rate of approximately five light signals every 10 seconds whereas if the golf ball 20 is approximately live yards from the remote controlling unit 50, then the lighting element 54 produces light signals at a rate of approximately 30 light signals every 10 seconds. Thus, if the golf ball 20 has been misplaced in an area (e.g., a water region) where it cannot be heard by a user, then the proximity of the golf ball 20 may still be determined based on the timing frequency of the light signals emitting from the lighting element 54.

According to embodiments of the present invention, the present invention is not limited to producing light signals at a particular rate or amplifying signals at a particular rate and may vary as needed. Further, each of these rates may be user-defined or may be preset during manufacturing of the portably golf ball tracking system.

A user may turn off the remote controlling unit 50 upon locating the golf ball 20 or the system may be designed to include an automatic cut-off function.

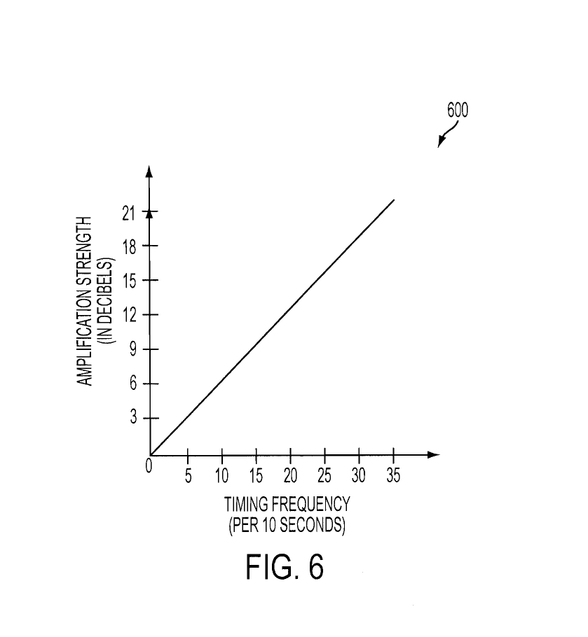

According to another embodiment of the present invention, a timing frequency of the light signals produced by the lighting element is in direct correlation with an amplification strength of the amplified second signal as shown in the graph 600 in FIG. 6. In FIG. 6, the timing frequency of the light signals emitted increases as the amplification strength of the signal 31 increases. For example, if the timing frequency of the lighting signals is approximately 5 light signals every 10 seconds, then the amplification strength of the signal 31 is approximately 3 decibels (db), whereas if the timing frequency of the light signals is approximately 30 light signals every 10 seconds then the amplification strength of the signal 31 is approximately 18 decibels (db), the present invention is not limited hereto and may vary accordingly.

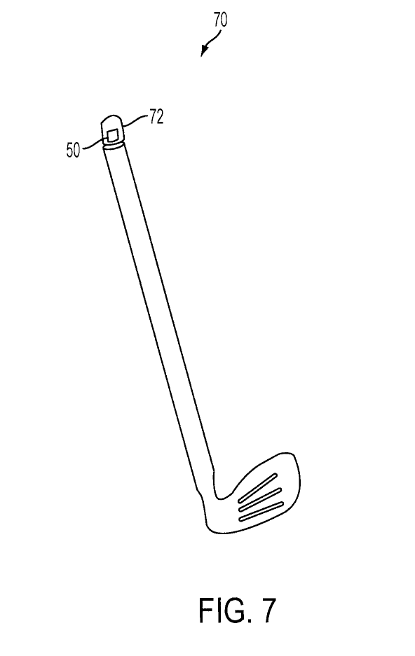

According to embodiments of the present invention, the remote controlling unit 50 is a portable device that may be handheld by the user. FIG. 7 is a diagram illustrating one example of the remote controlling unit 50 that can be implemented within embodiments of the present invention. As shown in FIG. 7, a golf club 70 is provided. The golf club 70 includes an upper handle 72. According to one embodiment of the present invention, the remote controlling unit 50 may be disposed within the upper handle 72 of the golf club 70.

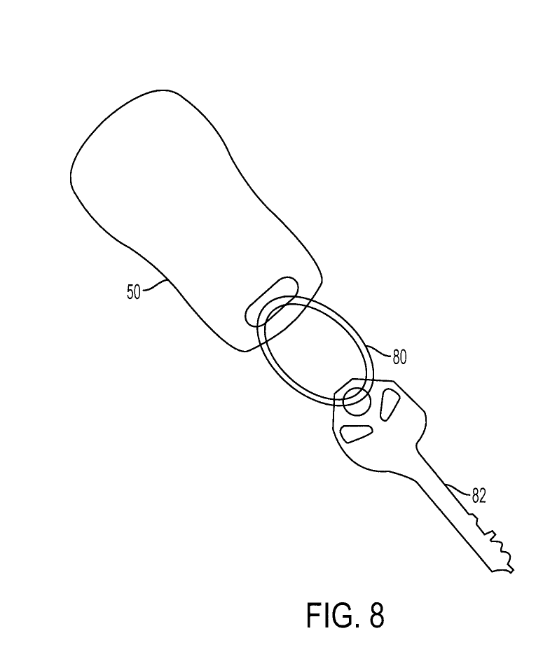

According to another embodiment of the present invention, as shown in FIG. 8, the remote controlling unit 50 may be disposed on a key chain 80 configured to hold a plurality of keys 82.

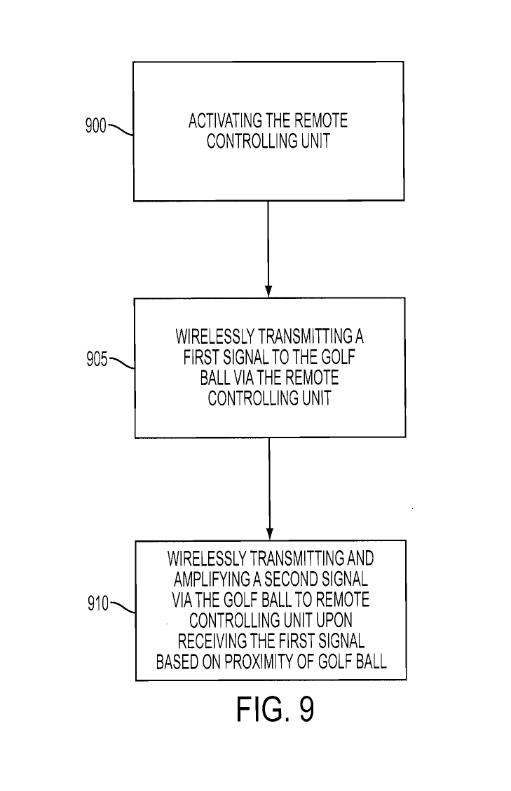

A method for tracking golf balls via the system 100 shown in FIG. 1 will now be discussed with reference to the flowchart shown in FIG. 9. As shown in FIG. 9, operation 900 includes activating, via a user, a remote controlling unit for tracking a golf ball. This may be performed via a user pressing the input device 58 on the front of the remote controlling unit 50. Next, operation 905 includes wirelessly transmitting, via the remote controlling unit 50, a first signal 51 to the golf ball 20. Then, wirelessly transmitting and amplifying a second signal 31 via the golf ball 20 to the remote controlling unit 50, upon receiving the first signal 51 at the golf ball based on proximity of the golf ball 20 to the remote controlling unit 50. Further, as previously mentioned above, a light signal may be emitted via a lighting element 54 at the remote controlling unit 50 to indicate the proximity of the golf ball to the remote controlling unit.

Embodiments of the present invention provide a golf ball tracking system that is a portable device to easily be handled by a user and enable a user to quickly locate any misplaced or wayward golf balls. Therefore, the present invention provides the advantages of saving time and money of the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is nut intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

What is claimed is:

1. A portable golf ball tracking system comprising:
a golf ball comprising:
a first transmitting and receiving unit configured to wirelessly receive and transmit signals to and from the golf ball,
a signal amplifying unit configured to receive the signals from the first transmitting and receiving unit and to amplify the signals; and
a remote controlling unit comprising:
a second transmitting and receiving unit configured to wirelessly receive and transmit signals to and from the first transmitting and receiving unit, and
a lighting element configured to produce a plurality of light signals based on the signals received from the golf ball, wherein the light signals indicate proximity of the golf ball to the remote controlling unit.

2. The portable golf tracking system of claim 1, wherein the golf ball further comprises:
a core area comprising the first transmitting and receiving unit and the signal amplifying unit and a shock-absorbing material surrounding the first transmitting and receiving unit and the signal amplifying unit;
an outer shell forming an external surface of the golf ball; and
an inner shell disposed between the core area and the outer shell.

3. The portable golf tracking system of claim 1, wherein the remote controlling unit further comprises:
a power supply unit configured to supply power to the remote controlling unit, wherein the lighting element indicates a status of the power of the remote controlling unit.

4. The portable golf ball tracking system of claim 1, wherein the remote controlling unit further comprising:
at least one input device configured to activate and deactivate the remote controlling unit, wherein upon activating the remote controlling unit, the second transmitting and receiving unit transmits a first signal to the first transmitting and receiving unit to determine a location of the golf ball and upon receiving the first signal, the first transmitting and receiving unit transmits a second signal to the second transmitting and receiving unit, the second signal being amplified via the signal amplifying unit indicating the proximity of the golf ball from the remote controlling unit.

5. The portable golf ball tracking system of claim 4, wherein an amplification strength of the amplified second signal corresponds to the proximity of the golf ball to the remote controlling unit.

6. The portable golf ball tracking system of claim 4, wherein a timing frequency of light signal emitted from the lighting element is in direct correlation with the proximity of the golf ball.

7. The portable golf ball tracking system of claim 4, wherein a timing frequency of the light signals produced by the lighting element is in direct correlation with an amplification strength of the amplified second signal.

8. The portable golf ball tracking system of claim 1, wherein in the golf ball is water-resistant.

9. The portable golf ball tracking system of claim 1, wherein the remote controlling unit is configured to track the golf ball in a predetermined ranging of approximately 1 yards to 30 yards.

10. The portable golf ball tracking system of claim 1, wherein the remote controlling unit is disposed within a golf club.

11. The portable golf ball tracking system of claim 1, wherein the remote controlling unit is a handheld device.

12. The portable golf ball racking system of claim 11, wherein the remote controlling unit is disposed on a key chain configured to hold a plurality of keys.

13. The portable golf ball tracking system of claim 1, wherein wirelessly transmitting and receiving of signals between the remote controlling unit and the golf ball are performed using global positioning system (GPS) technology.

14. The portable golf ball tracking system of claim 1, wherein the lighting element comprises at least one light emitting diode.

15. A method of tracking golf balls via a golf ball tracking system, the method comprising:
activating, via a user, a remote controlling unit for tracking a golf ball;
wirelessly transmitting, via the remote controlling unit, a first signal to the golf ball; and
wirelessly transmitting and amplifying a second signal via the golf ball to the remote controlling unit, upon receiving the first signal at the golf ball based on proximity of the golf ball to the remote controlling unit.

16. The method of claim 15, further comprising:
emitting a light signal, via a lighting element at the remote controlling unit indicating the proximity of the golf ball to the remote controlling unit.

17. The method of claim 15, wherein an amplification strength of the amplified second signal corresponds to the proximity of the golf ball to the remote controlling unit.

18. The method of claim 16, wherein a timing frequency of the light signal emitted from the lighting element is in direct correlation with the proximity of the golf ball.

19. The method of claim 16, wherein the timing frequency of the light signal emitted from the lighting element is in direct correlation with an amplification strength of the amplified second signal.

20. The method of claim 15, wherein wireless transmitting and receiving is performed using global positioning system (GPS) technology.
